(19) United States
(12) Patent Application Publication
(10) Pub. No.: US 2014/0002256 A1
(43) Pub. Date: Jan. 2, 2014

(54) VEHICLE AND CONTROL METHOD FOR VEHICLE

(71) Applicant: Takeshi Hoshiba, Anjo-shi (JP)

(72) Inventor: Takeshi Hoshiba, Anjo-shi (JP)

(73) Assignee: TOYOTA JIDOSHA KABUSHKI KAISHA, Toyota-shi, Aichi-ken (JP)

(21) Appl. No.: 14/006,632

(22) PCT Filed: Mar. 24, 2011
(86) PCT No.: PCT/JP2011/057151

§ 371 Date: Sep. 20, 2013

(51) Int. Cl. B60Q 1/00

(52) U.S. Cl. CPC B60Q 1/00
USPC 340/441

(57) ABSTRACT

An ECU executes a program including: a step of bringing a “READY” mark into a flashing state when there is a request to restart a system of a vehicle during traveling and when start of an engine is necessary; a step of starting the engine when an engine rotational speed Ne is equal to or lower than a prescribed rotational speed Ne and when start of the engine is possible; a step of shifting the “READY” mark from the flashing state to a constantly lighting state when start of the engine is completed; and a step of bringing the “READY” mark into the constantly lighting state when start of the engine is unnecessary.

### TECHNICAL FIELD

The present invention relates to control of a vehicle having a rotating electric machine and an internal combustion engine

### BACKGROUND ART

Japanese Patent Laying-Open No. 2007-23919 (PTD 1) discloses an engine start control system disclosing a technique of restarting an engine when a push switch is pushed even if a brake pedal is not depressed if the engine has stopped due to some cause while a vehicle is traveling.

In addition, in recent years, as one of the countermeasures against environmental problems, hybrid vehicles equipped with a motor generator and an engine have received attention. A publicly known example of such a hybrid vehicle is a vehicle with elements: drive wheels, an engine, and a motor generator which are mechanically coupled together.

### CITATION LIST

### Patent Document

PTD 1: Japanese Patent Laying-Open No. 2007-23919

### SUMMARY OF INVENTION

### Technical Problem

In the aforementioned hybrid vehicle, a system of the vehicle may sometimes be stopped during traveling due to wrong operation by an occupant. In such a case, when the occupant performs an operation for restarting the system which is in a stop state, there arises such a problem that the occupant cannot recognize the restart situation of the system. This is because it is unclear whether the operation for restarting the system has been accepted or not.

An object of the present invention is to provide a vehicle and a control method for a vehicle, which allows the occupant to recognize the restart situation of the system.

### Solution to Problem

A vehicle according to an aspect of the present invention includes: a notification unit for notifying an occupant of a start state of a system of a vehicle, an input unit for receiving a stop command and a start command for the system of the vehicle from the occupant; and a control unit for notifying the occupant in a first manner, using the notification unit, that the start command has been accepted, when the stop command has been received at the input unit while the vehicle is traveling, and thereafter the start command has been received at the input unit.

Preferably, the vehicle further includes an internal combustion engine. The first manner is a manner for notifying the occupant that equipment necessary to start the internal combustion engine is in an operable state.

More preferably, the first manner is a manner for notifying the occupant that the vehicle is in a traveling preparation state. When the stop command has been received at the input unit and thereafter the start command has been received at the input unit during the traveling, and when start of the internal combustion engine is requested, the control unit notifies the occupant in the first manner, using the notification unit, that the start command has been accepted, until the internal combustion engine starts.

More preferably, the vehicle further includes: a rotating electric machine for driving; and an internal combustion engine. When the stop command has been received at the input unit and thereafter the start command has been received at the input unit during the traveling, and when the rotating electric machine for driving causes the vehicle to travel with the internal combustion engine stopped, the control unit notifies the occupant in a second manner different from the first manner, using the notification unit.

More preferably, the first manner is a manner in which a mark having a predetermined shape flashes. The second manner is a manner in which the mark constantly lights up.

More preferably, the first manner is a manner that allows the occupant to recognize by sound that the start command has been accepted. The second manner is a manner that allows the occupant to recognize by sound that the vehicle is in a traveling permitted state.

More preferably, the notification unit includes: a first display unit for displaying to the occupant in the first manner that the start command has been accepted, in response to reception of the start command at the input unit from the occupant; and a second display unit provided at a position different from that of the first display unit, for displaying to the occupant in the second manner that the vehicle is in a traveling permitted state.

More preferably, the vehicle further includes: a drive shaft for causing a drive wheel to rotate; an internal combustion engine; a first rotating electric machine; and a power transmission device mechanically coupling three elements, which are the drive shaft, an output shaft of the internal combustion engine, and a rotation shaft of the first rotating electric machine, the power transmission device utilizing any one of the three elements as a reaction force element, thereby allowing for transmission of motive power between the other two elements.

A control method for a vehicle according to another aspect of the present invention is a control method for a vehicle used in a vehicle having a notification unit for notifying an occupant of a start state of a system of the vehicle. The control method for a vehicle includes the steps of: determining whether either one of a stop command and a start command for the system of the vehicle has been received from the occupant or not; and notifying the occupant in a first manner, using the notification unit, that the start command has been accepted, when the stop command has been received while the vehicle is traveling, and thereafter the start command has been received.

### Advantageous Effects of Invention

According to the present invention, when the system of the vehicle stops and thereafter restart is requested during traveling, the occupant can recognize that the start command has been accepted, by notification in the first manner using the notification unit. Therefore, there can be provided a vehicle and a control method for a vehicle, which allows the occupant to recognize the restart situation of the system.

### BRIEF DESCRIPTION OF DRAWINGS

FIG. 1 is an overall block diagram of a vehicle according to the present embodiment.

FIG. 2 is a diagram showing a configuration of a meter mounted on the vehicle according to the present embodiment.

FIG. 3 is a functional block diagram of an ECU mounted on the vehicle according to the present embodiment.

FIG. 4 is a nomographic chart for illustrating operation of the vehicle in the present embodiment.

FIG. 5 is a flowchart showing a control structure of a program executed by the ECU mounted on the vehicle according to the present embodiment.

FIG. 6 is a timing chart for illustrating operation of the vehicle according to the present embodiment.

### DESCRIPTION OF EMBODIMENTS

Embodiments of the present invention will be described hereinafter, with reference to the drawings. In the following description, the same components are denoted by the same symbols. The names and functions thereof are also the same. Accordingly, detailed description thereof will not be repeated.

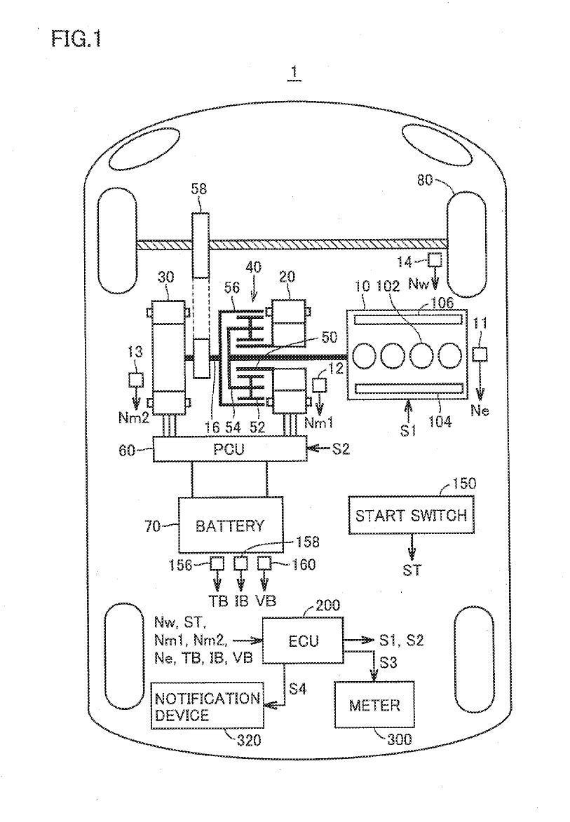

Referring to FIG. 1, an overall block diagram of a vehicle 1 according to the present embodiment will be described. Vehicle 1 includes an engine 10, a drive shaft 16, a first motor generator (hereinafter referred to as first MG) 20, a second motor generator (hereinafter referred to as second MG) 30, a power split device 40, a speed reducer 58, a PCU (Power Control Unit) 60, a battery 70, drive wheels 80, a start switch 150, an ECU (Electronic Control Unit) 200, a meter 300, and a notification device 320.

Vehicle 1 travels with driving force output from at least one of engine 10 and second MG 30. Motive power generated by engine 10 is split for two paths by power split device 40. Of the two paths, one is a path for transmission via speed reducer 58 to drive wheels 80, and the other is a path for transmission to first MG 20.

First MG 20 and second MG 30 are, for example, three-phase AC rotating electric machines. First MG 20 and second MG 30 are driven by PCU 60.

First MG 20 has a function as a generator which generates power using motive power of engine 10 split by power split device 40, to charge battery 70 via PCU 60. In addition, receiving power from battery 70, first MG 20 rotates a crankshaft of engine 10 which serves as an output shaft. Thus, first MG 20 has a function as a starter which starts engine 10.

Second MG 30 has a function as a drive motor which provides driving force for drive wheels 80 using at least any one of power stored in battery 70 and power generated by first MG 20. In addition, second MG 30 has a function as a generator for charging battery 70 via PCU 60 with the use of power generated through regenerative braking.

Engine 10 is, for example, an internal combustion engine such as a gasoline engine and a diesel engine. Engine 10 includes a plurality of cylinders 102, a fuel injection device 104 which supplies fuel to each of the plurality of cylinders 102, and an ignition device 106 for igniting the fuel in the plurality of cylinders 102. Based on a control signal S1 from ECU 200, fuel injection device 104 injects an appropriate amount of fuel for each cylinder with appropriate timing and stops injecting fuel for each cylinder. Based on control signal S1 from the ECU, ignition device 106 sparks an ignition plug of each cylinder at an appropriate time.

For the detection of the rotational speed of the crankshaft of engine 10 (hereinafter referred to as engine rotational speed) Ne, engine 10 is further provided with an engine rotational speed sensor 11. Engine rotational speed sensor 11 transmits a signal indicating detected engine rotational speed Ne to ECU 200.

Power split device 40 mechanically couples together three elements for rotating drive wheels 80: drive shaft 16, the output shaft of engine 10, and a rotation shaft of first MG 20. Power split device 40 utilizes any one of the above-indicated three elements as a reaction force element, thereby allowing for the transfer of motive power between the other two elements. A rotation shaft of second MG 30 is coupled to drive shaft 16.

Power split device 40 is a planetary gear mechanism including a sun gear 50, pinion gears 52, a carrier 54, and a ring gear 56. Pinion gear 52 engages with each of sun gear 50 and ring gear 56. Carrier 54 supports pinion gears 52 in a manner to allow them to rotate, and is coupled to a crankshaft of engine 10. Sun gear 50 is coupled to the rotation shaft of first MG 20. Ring gear 56 is coupled via drive shaft 16 to the rotation shaft of second MG 30 and speed reducer 58.

Speed reducer 58 transfers motive power from power split device 40 and second MG 30 to drive wheels 80. In addition, speed reducer 58 transfers reaction force received by drive wheels 80 from a road surface, to power split device 40 and second MG 30

PCU 60 converts DC power stored in battery 70 into AC power for driving first MG 20 and second MG 30. PCU 60 includes a converter and an inverter (both not shown) which are controlled based on a control signal S2 from ECU 200. The converter boosts a voltage of DC power received from battery 70 and outputs the boosted power to the inverter. The inverter converts the DC power output from the converter into AC power for output to first MG 20 and/or second MG 30. First MG 20 and/or second MG 30 are thus driven by using the power stored in battery 70. In addition, the inverter converts AC power generated by first MG 20 and/or second MG 30 into DC power and outputs it to the converter. The converter steps down a voltage of the DC power output by the inverter and outputs the stepped down power to battery 70. Battery 70 is thereby charged with the use of the power generated by first MG 20 and/or second MG 30. It is noted that the converter may be omitted.

Battery 70 is a power storage device and a rechargeable DC power supply. As battery 70, for example, a secondary battery such as a nickel-metal hydride secondary battery and a lithium ion secondary battery is used. Battery 70 has a voltage of the order of 200 V, for example. Battery 70 may be charged, other than with the use of the power generated by first MG 20 and/or second MG 30 as described above, with the use of power supplied from an external power supply (not shown). It is noted that battery 70 is not limited to a secondary battery, and may be anything that can generate a DC voltage, such as a capacitor, a solar cell, and a fuel cell, for example.

Battery 70 is provided with a battery temperature sensor 156 for detecting a battery temperature TB of battery 70, a current sensor 158 for detecting a current IB of battery 70, and a voltage sensor 160 for detecting a voltage VB of battery 70

Battery temperature sensor 156 transmits a signal indicating battery temperature TB to ECU 200. Current sensor 158 transmits a signal indicating current IB to ECU 200. Voltage sensor 160 transmits a signal indicating voltage VB to ECU 200.

Start switch 150 is, for example, a push switch. Start switch 150 may be one that allows a key to be inserted into a key cylinder and rotated to a prescribed position. Start switch 150 is connected to ECU 200. In response to an operation of start switch 150 by an occupant such as a driver, start switch 150 transmits a signal ST to ECU 200.

ECU 200 determines that a start command has been received when, for example, signal ST has been received while the system of vehicle 1 is in a stop state, and then ECU 200 shifts the system of vehicle 1 from the stop state to a startup state In addition, ECU 200 determines that a stop command has been received when signal ST has been received while the system of vehicle 1 is in the startup state, and then ECU 200 shifts the system of vehicle 1 from the startup state to the stop state. In the following descriptions, operation of start switch 150 by the occupant when the system of vehicle 1 is in the startup state will be referred to as an IG OFF operation, and operation of start switch 150 by the occupant when the system of vehicle 1 is in the stop state will be referred to as an IG ON operation. Once the system of vehicle 1 shifts to the startup state, for example, a plurality of pieces of equipment necessary for vehicle 1 to travel are supplied with power, and then enter an operable state. In contrast, once the system of vehicle 1 shifts to the stop state, for example, part of the plurality of pieces of equipment necessary for vehicle 1 to travel are no longer supplied with power, and then enter an operation stop state.

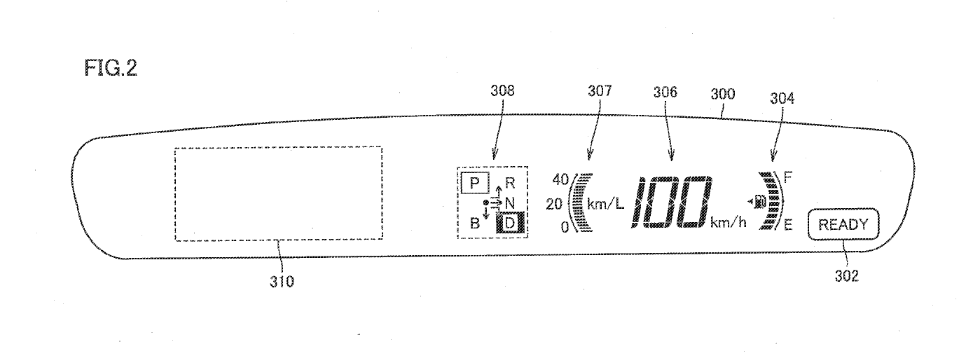

As shown in FIG. 2, meter 300 includes a first display unit 302 for displaying a mark having a predetermined shape, a second display unit 304 for displaying a remaining amount of fuel, a third display unit 306 for displaying the speed of vehicle 1, a fourth display unit 308 for displaying fuel efficiency, and a fifth display unit 310 for displaying other information about vehicle 1. In the present embodiment, the mark having a predetermined shape is a “READY” mark.

First display unit 302 notifies the occupant of the state of the vehicle in either one of a first manner and a second manner. Specifically, the first manner is a manner in which the “READY” mark flashes, and first display unit 302 notifies the occupant in this first manner that vehicle 1 is in a traveling preparation state. Furthermore, the second manner is a manner in which the “READY” mark constantly lights up, and first display unit 302 notifies the occupant in this second manner that vehicle 1 is in a traveling permitted state.

Vehicle 1 being in the traveling permitted state refers to, for example, a state in which vehicle 1 can start traveling by occupant's depression of the accelerator pedal. Vehicle 1 being in the traveling preparation state refers to a state in which an operation for bringing vehicle 1 into the traveling permitted state is being performed, e.g., a state in which it is being checked whether there is an abnormality in the system of vehicle 1 or not in response to the IG ON operation for start switch 150. When vehicle 1 is in the traveling preparation state, the equipment necessary to start engine 10 is in an operable state. It is noted that the configuration of meter 300 is not limited to the configuration shown in FIG. 2.

Based on a control signal S3 from ECU 200, each of first display unit 302 to fifth display unit 310 lights up, goes out, displays information, or updates the displayed information.

Notification device 320 is, for example, a sound generating device or a display device The sound generating device may be, for example, a device that generates sound, or a device that generates warning sound. The display device may be, for example, meter 300, or an LCD (Liquid Crystal Display) provided at a position different from that of meter 300, or an indicator provided at a position different from that of meter 300.

Notification device 320 may be, for example, an indicator which is provided at start switch 150 and has display colors changed in response to the operation for start switch 150. The indicator may be, for example, an indicator having display colors changed such that the indicator goes out at the time of IG OFF or lights up in a prescribed color at the time of ACC ON and lights up in a color different from the aforementioned prescribed color at the time of IG ON. Based on a control signal S4 from ECU 200, notification device 320 notifies the occupant of various types of information in a prescribed manner. The prescribed manner includes, for example, a constantly lighting state of the indicator, a flashing state of the indicator, a lights-out state of the indicator, a warning by sound, display of a warning, and the like.

A first resolver 12 detects rotational speed Nm1 of first MG 20. First resolver 12 transmits a signal indicating detected rotational speed Nm1 to ECU 200. A second resolver 13 detects rotational speed Nm2 of second MG 30. Second resolver 13 transmits a signal indicating detected rotational speed Nm2 to ECU 200

A wheel speed sensor 14 detects rotational speed Nw of drive wheels 80. Wheel speed sensor 14 transmits a signal indicating detected rotational speed Nw to ECU 200. ECU 200 calculates vehicle speed V based on rotational speed Nw received. It is noted that ECU 200 may calculate vehicle speed V based on rotational speed Nm2 of second MG 30 instead of rotational speed Nw.

ECU 200 generates control signal S1 for controlling engine 10 and outputs generated control signal S1 to engine 10. Further, ECU 200 generates control signal S2 for controlling PCU 60 and outputs generated control signal S2 to PCU 60.

By controlling engine 10, PCU 60, and the like, ECU 200 controls the entire hybrid system, that is, a state of charging/discharging of battery 70 and states of operation of engine 10, first MG 20 and second MG 30 such that vehicle 1 can travel most efficiently.

ECU 200 calculates requested power which corresponds to an amount of depression of an accelerator pedal (not shown) provided at a driver's seat. ECU 200 controls torque of first MG 20 and second MG 30, and an output of engine 10, in accordance with the calculated requested power.

Vehicle 1 having a configuration as described above travels solely on second MG 30 when engine 10 is inefficient at the start of traveling or during low-speed traveling. In addition, during normal traveling, for example, power split device 40 divides motive power of engine 10 into two paths of motive power. Motive power in one path directly drives drive wheels 80. Motive power in the other path drives first MG 20 to generate power. At this time, ECU 200 uses generated power to drive second MG 30. In this way, by driving second MG 30, assistance in driving drive wheels 80 is provided.

When vehicle 1 reduces its speed, regenerative braking is performed with second MG 30, which follows the rotation of drive wheels 80, functioning as a generator. The power recovered through regenerative braking is stored in battery 70. It is noted that when remaining capacitance (hereinafter referred to as SOC (State of Charge)) of the power storage device has lowered and is particularly in need of charging, ECU 200 increases an output of engine 10 to increase an amount of power generated by first MG 20. The SOC of battery 70 is thereby increased. In addition, even during low-speed traveling, ECU 200 may exert control for increasing driving force from engine 10 as necessary, for example, such as when battery 70 is in need of charging as described above, when auxiliary machinery such as an air conditioner is to be driven, and when the temperature of cooling water for engine 10 is to be raised to a prescribed temperature.

In controlling amounts of charging and discharging of battery 70, ECU 200 sets, based on battery temperature TB and the current SOC, allowable input power in charging battery 70 (hereinafter referred to as “charge power upper limit value Win”) and allowable output power in discharging battery 70 (hereinafter referred to as “discharge power upper limit value Wout”). For instance, as the current SOC gets lower, discharge power upper limit value Wout is gradually set lower. In contrast, as the current SOC gets higher, charge power upper limit value Win is gradually set lower.

In addition, the secondary battery used as battery 70 has temperature dependence that causes an increase in internal resistance at low temperatures. In addition, at high temperatures, it is necessary to prevent an overincrease in temperature caused by further heat generation. It is therefore preferable to lower each of discharge power upper limit value Wout and charge power upper limit value Win when battery temperature TB is low and when battery temperature TB is high. ECU 200 sets charge power upper limit value Win and discharge power upper limit value Wout in accordance with battery temperature TB and the current SOC, for example, through the use of a map or the like.

In vehicle 1 having the aforementioned configuration, the system of vehicle 1 may sometimes be stopped during traveling due to the IG OFF operation wrongly performed by the occupant. When the occupant performs the operation for restarting the system which is in the stop state, the occupant cannot recognize the restart situation of the system in some cases. This is because it is unclear whether the operation for restarting the system has been accepted or not.

Thus, the present embodiment is characterized in that, when the stop command has been received and thereafter the start command has been received at start switch 150 while vehicle 1 is traveling, ECU 200 notifies the occupant in the first manner, using meter 300 or notification device 320, that the start command has been accepted.

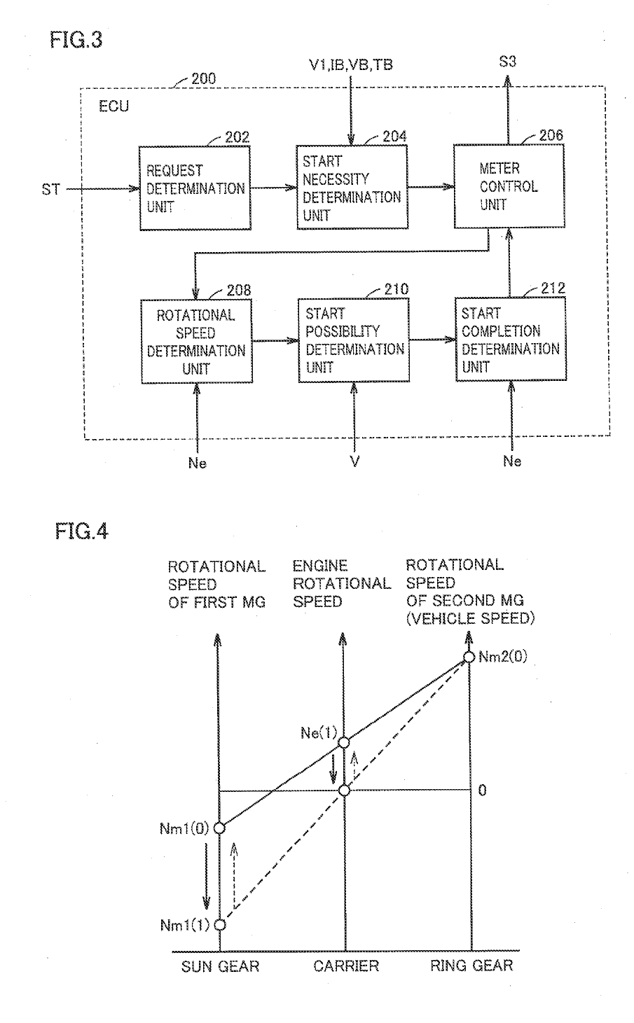

FIG. 3 shows a functional block diagram of ECU 200 mounted on vehicle 1 according to the present embodiment. ECU 200 includes a request determination unit 202, a start necessity determination unit 204, a meter control unit 206, a rotational speed determination unit 208, a start possibility determination unit 210, and a start completion determination unit 212.

Request determination unit 202 determines whether a request to restart the system of vehicle 1 has been received or not while vehicle 1 is traveling. Specifically, based on the ST signal from start switch 150, request determination unit 202 determines whether or not the IG OFF operation has been performed and thereafter the IG ON operation has been performed while vehicle 1 is traveling. For example, request determination unit 202 may turn a restart request determination flag on when the request to restart the system of vehicle 1 has been received while vehicle 1 is traveling.

When request determination unit 202 has determined that the request to restart the system of vehicle 1 has been received, start necessity determination unit 204 determines whether start of engine 10 is necessary or not.

Start necessity determination unit 204 determines whether start of engine 10 is necessary or not, based on, for example, the requested power, the SOC of battery 70 or the like. The requested power is calculated based on vehicle speed V and the like in addition to the aforementioned amount of depression of the accelerator pedal. The requested power may be calculated from, for example, a map showing a relationship among vehicle speed V, the amount of depression of the accelerator pedal and the requested power.

When the calculated requested power cannot be satisfied by the output of second MG 30, start necessity determination unit 204 determines that start of engine 10 is necessary. Alternatively, when the SOC of battery 70 is lower than a threshold value for determining whether start of engine 10 is necessary or not, start necessity determination unit 204 determines that start of engine 10 is necessary for power generation with first MG 20.

For example, start necessity determination unit 204 may determine whether start of engine 10 is necessary or not when the restart request determination flag is on, and may turn a start necessity determination flag on when it has been determined that start of engine 10 is necessary.

Based on the result of determination by start necessity determination unit 204, meter control unit 206 executes lighting control over the “READY” mark on first display unit 302 in order to notify the occupant that the start command has been accepted. Based on the result of determination by start necessity determination unit 204, meter control unit 206 generates control signal S3 and transmits control signal S3 to meter 300.

When start necessity determination unit 204 has determined that start of engine 10 is not necessary, meter control unit 206 controls meter 300 such that the “READY” mark enters the constantly lighting state.

When start necessity determination unit 204 has determined that start of engine 10 is necessary, meter control unit 206 controls meter 300 such that the “READY” mark enters the flashing state.

When below-described start completion determination unit 212 has determined that start of engine 10 has been completed, meter control unit 206 shifts the “READY” mark from the flashing state to the constantly lighting state. Meter control unit 206 may shift the “READY” mark from the flashing state to the constantly lighting state, for example, when a below-described start completion determination flag is switched from the off state to the on state.

For example, meter control unit 206 may control meter 300 such that the “READY” mark enters the constantly lighting state when the start necessity determination flag is off, and such that the “READY” mark enters the flashing state when the start necessity determination flag is on.

Rotational speed determination unit 208 determines whether or not rotational speed Ne of engine 10 is a prescribed rotational speed Ne(0) or lower. Prescribed rotational speed Ne(0) or lower refers to being within a region of the rotational speed of engine 10 in which cranking with first MG 20 is impossible.

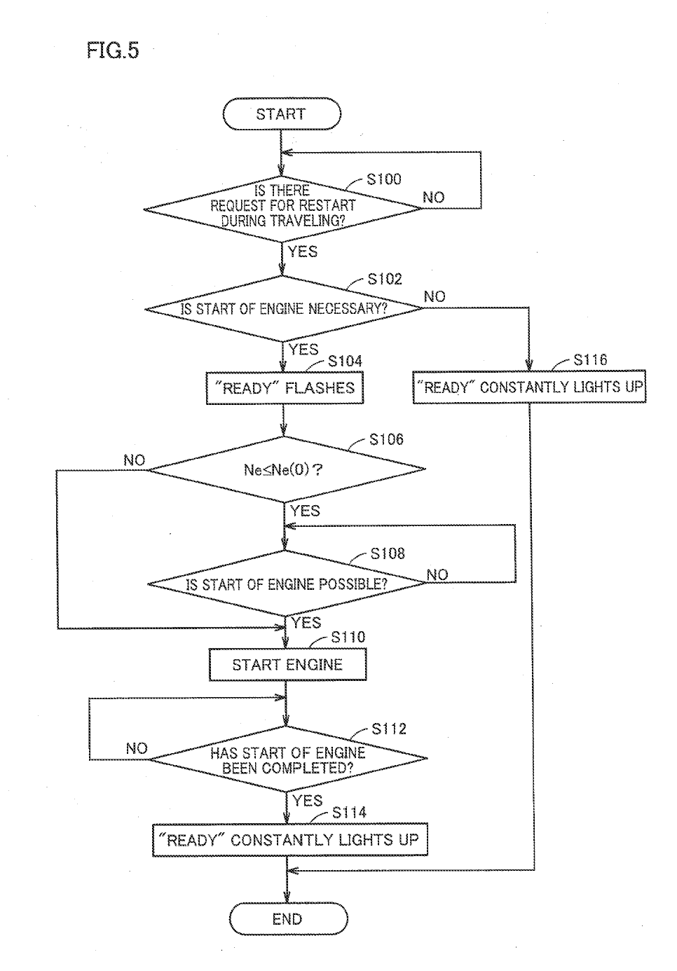

If engine 10 has stopped due to some cause during high-speed traveling, the engine cannot in some cases be restarted immediately. It is assumed that vehicle 1 is traveling at high speed, as indicated by the solid line shown in the nomographic chart of FIG. 4, for example.

Of the three vertical axes of the nomographic chart shown in FIG. 4, the left vertical axis indicates the rotational speed of sun gear 50, that is, rotational speed Nm1 of first MG 20. The center vertical axis of the nomographic chart shown in FIG. 4 indicates the rotational speed of carrier 54, that is, engine rotational speed Ne. The right vertical axis of the nomographic chart shown in FIG. 4 indicates the rotational speed of ring gear 56, that is, rotational speed Nm2 of second MG 30. It is noted that the direction of an arrow formed by each vertical axis of the nomographic chart of FIG. 4 indicates a positive rotational direction, and a direction opposite to the direction of the arrow indicates a negative rotational direction.

While vehicle 1 is traveling, rotational speed Nm1 of first MG 20, engine rotational speed Ne, and rotational speed Nm2 of second MG 30 vary in such a manner that rotational speeds Nm1, Ne and Nm2 of these elements maintain such a relation that they are connected by a straight line in the nomographic chart of FIG. 4.

As indicated by the solid line in FIG. 4, it is assumed that rotational speed Nm1 of first MG 20 is Nm1(0), engine rotational speed Ne is Ne(1), and rotational speed Nm2 of second MG 30 is Nm2(0).

If rotation of engine 10 has stopped when the IG OFF operation is performed while vehicle 1 is traveling at high speed, vehicle 1 enters a state indicated by the broken line in FIG. 2. It is now assumed that engine 10 is started using first MG 20. In this case, it is necessary to increase engine rotational speed Ne to be higher than a lowest engine rotational speed at which first explosion can occur, by elevating rotational speed Nm1 of first MG 20 from Nm1(1) to Nm1(0).

It is thus necessary to generate torque in the positive rotational direction opposite to a rotational direction of first MG 20 (negative rotational direction). First MG 20, however, generates power in the process of elevating the rotational speed of first MG 20 from Nm1(1) to Nm1(0). Thus, if charging is restricted due to the SOC of battery 70 being higher than a normal SOC range, that is, if charge power upper limit value Win is lower than a case where the SOC is within the normal SOC range, first MG 20 may not be able to generate power. As a result, engine 10 cannot in some cases be restarted immediately.

Therefore, determination as to whether or not engine rotational speed Ne is prescribed rotational speed Ne(0) or lower refers to determination as to whether or not engine 10 can be started immediately by using first MG 20. Engine rotational speed Ne being prescribed rotational speed Ne(0) or lower refers to a state in which engine 10 cannot be started immediately by using first MG 20. Prescribed rotational speed Ne(0) is a threshold value of engine rotational speed Ne for determining whether or not engine 10 can be started immediately by using first MG 20.

For example, rotational speed determination unit 208 may determine whether or not engine rotational speed Ne is prescribed rotational speed Ne(0) or lower when the start necessity determination flag is on, and may turn a rotational speed determination flag on when engine rotational speed Ne is prescribed rotational speed Ne(0) or lower.

Start possibility determination unit 210 determines whether start of engine 10 is possible or not. Specifically, start possibility determination unit 210 determines whether or not vehicle speed V is within a region of speed in which engine 10 can be started by using first MG 20 (i.e., whether or not vehicle speed V is a threshold value V(0) or lower). When vehicle speed V is within the region of speed in which engine 10 can be started by using first MG 20, start possibility determination unit 210 determines that start of engine 10 is possible. For example, start possibility determination unit 210 may turn a start possible determination flag on when start of engine 10 is possible.

Start completion determination unit 212 determines whether start of engine 10 has been completed or not. Specifically, when engine rotational speed Ne is higher than a prescribed rotational speed Ne(2) indicating that engine 10 has already been started, start completion determination unit 212 determines that start of engine 10 has been completed. For example, start completion determination unit 212 may turn a completion determination flag on when start of engine 10 has been completed. Prescribed rotational speed Ne(2) indicating that engine 10 has already been started refers to, for example, a rotational speed at which engine 10 can completely explode (self-operation is possible).

Although request determination unit 202, start necessity determination unit 204, meter control unit 206, rotational speed determination unit 208, start possibility determination unit 210, and start completion determination unit 212 are described in the present embodiment as realized through execution of a program stored in a memory by a CPU of ECU 200 and as functioning as software, they may be realized by hardware. It is noted that such a program is recorded in a storage medium for installation in the vehicle.

Referring to FIG. 5, a control structure of a program executed by ECU 200 mounted on vehicle 1 according to the present embodiment will be described.

In step (“step” will hereinafter be denoted as “S”) 100, ECU 200 determines whether or not there is a request to restart the system while vehicle 1 is traveling. If there is a request to restart the system of vehicle 1 while vehicle 1 is traveling (YES in S100), the process is transferred to S102. If not (NO in S100), the process is returned to S100.

In S102, ECU 200 determines whether start of engine 10 is necessary or not. Since a method for determining whether start of engine 10 is necessary or not has been described above, detailed description thereof will not be repeated. If start of engine 10 is necessary (YES in S102), the process is transferred to S104. If not (NO in S102), the process is transferred to S116.

In S104, ECU 200 controls meter 300 such that the “READY” mark on first display unit 302 enters the flashing state. In S106, ECU 200 determines whether or not engine rotational speed Ne is prescribed rotational speed Ne(0) or lower. If engine rotational speed Ne is prescribed rotational speed Ne(0) or lower (YES in S106), the process is transferred to S108. If not (NO in S106), the process is transferred to S110.

In S108, ECU 200 determines whether start of engine 10 is possible or not. Specifically, when vehicle speed V is prescribed vehicle speed V(0) or lower, ECU 200 determines that start of engine 10 is possible. If start of engine 10 is possible (YES in S108), the process is transferred to S110. If not (NO in S108), the process is returned to S108.

In S110, ECU 200 starts engine 10. Specifically, ECU 200 elevates the rotational speed of engine 10 by using first MG 20 to a rotational speed at which first explosion can occur in engine 10, and in addition, executes fuel injection control and ignition control.

In S112, ECU 200 determines whether start of engine 10 has been completed or not. If it has been determined that start of engine 10 has been completed (YES in S112), the process is transferred to S114. If not (NO in S112), the process is returned to S112.

In S114, ECU 200 controls meter 300 such that the “READY” mark shifts from the flashing state to the constantly lighting state. In S116, ECU 200 controls meter 300 such that the “READY” mark enters the constantly lighting state.

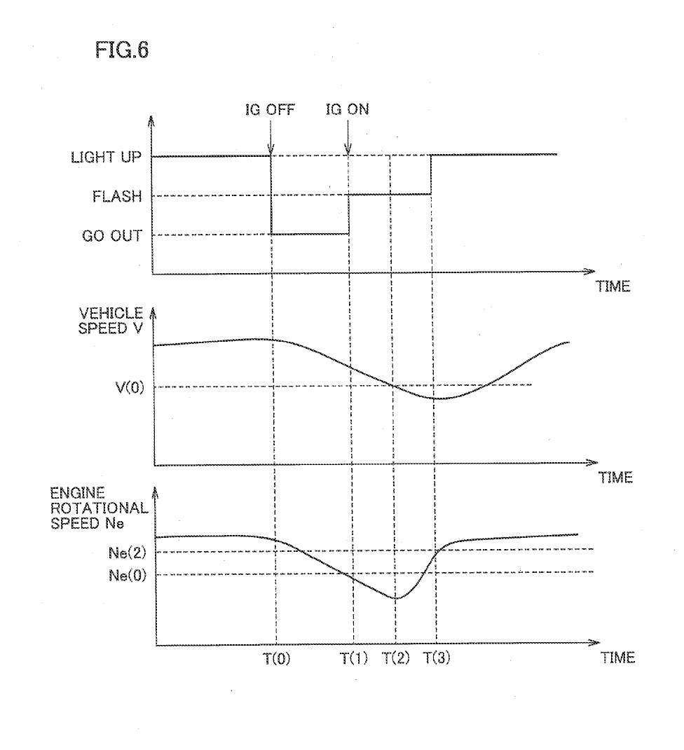

Operation of the ECU mounted on the vehicle according to the present embodiment based on the foregoing structure and flowchart will now be described with reference to FIG. 6.

As shown in FIG. 6, the case where vehicle 1 is traveling, with the system being in the start state (IG ON state), is assumed, for example. At this time, the “READY” mark on first display unit 302 is in the constantly lighting state. It is noted that the following case is assumed: vehicle speed V is higher than V(0) and engine rotational speed Ne is higher than Ne(2).

When the occupant performs the IG OFF operation for start switch 150 at time T(0), the “READY” mark goes out and fuel-cut control is executed on engine 10. Therefore, vehicle speed V and engine rotational speed Ne decrease with the passage of time.

When the occupant performs the IG ON operation for start switch 150 at time T(1) (YES in S100) and when it is determined that start of engine 10 is necessary (YES in S102), the “READY” mark enters the flashing state (S104). At this time, the occupant can recognize that the IG ON operation for start switch 150 has been accepted.

When vehicle speed V is higher than V(0) at time T(1), engine 10 is not started (NO in S108), even if engine rotational speed Ne decreases to Ne(0) or lower (YES in S106).

When vehicle speed V becomes lower than V(0) at time T(2), it is determined that start of engine 10 is possible (YES in S108), and thus, engine 10 is started (S110).

When engine rotational speed Ne becomes equal to or higher than Ne(1) and thereby start of engine 10 is completed at time T(3) (YES in S112), the “READY” mark on first display unit 302 shifts from the flashing state to the constantly lighting state (S114).

When it is determined that start of engine 10 is necessary (YES in S102) and when engine rotational speed Ne is higher than Ne(0) (NO in S106), engine 10 is started immediately (S110).

When it is determined that start of engine 10 is not necessary (NO in S102), the “READY” mark on first display unit 302 enters the constantly lighting state (S116) and vehicle 1 travels by using second MG 30, with engine 10 stopped.

As described above, in the vehicle according to the present embodiment, when the system of vehicle 1 stops and engine 10 stops and thereafter restart is requested during traveling, the “READY” mark on first display unit 302 enters the flashing state, even if engine 10 is not started immediately. As a result, the occupant can recognize that the request to restart the system of vehicle 1 has been accepted. Therefore, there can be provided a vehicle and a control method for a vehicle, which allows the occupant to recognize the restart situation of the system.

While FIG. 1 shows vehicle 1 having drive wheels 80 as front wheels by way of example, the present invention is not particularly limited to such a drive system. For example, vehicle 1 may have the drive wheels as rear wheels. Alternatively, vehicle 1 may be a vehicle in which second MG 30 in FIG. 1 is omitted. Still alternatively, vehicle 1 may be a vehicle in which second MG 30 in FIG. 1 is coupled to a drive shaft for driving the rear wheels, instead of being coupled to drive shaft 16 of the front wheels. Moreover, a speed change mechanism may be provided between drive shaft 16 and speed reducer 58 or between drive shaft 16 and second MG 30.

Alternatively, vehicle 1 may be configured such that second MG 30 is omitted, the rotation shaft of first MG 20 is directly coupled to the output shaft of engine 10, and a transmission having a clutch is provided instead of power split device 40.

Furthermore, while ECU 200 has been described as being a single ECU in FIG. 1, two or more ECUs may be used. For example, the operation of ECU 200 in FIG. 1 may be shared by an engine ECU for controlling engine 10 and a hybrid ECU for controlling PCU 60.

Furthermore, meter control unit 206 in FIG. 3 may notify the occupant that the start command has been accepted, by using notification device 320 instead of first display unit 302. When notification device 320 is the sound generating device, for example, meter control unit 206 may notify the occupant that the start command has been accepted, by generating warning sound or sound.

When notification device 320 is the display device such as the indicator, meter control unit 206 may notify the occupant that the start command has been accepted, by changing a lighting color of the indicator into a prescribed color different from a normal color (color when the start command has been accepted while vehicle 1 is in the stop state). Meter control unit 206 may notify the occupant that the start command has been accepted, by increasing or decreasing the brightness of the display device continuously or in a stepwise manner. Meter control unit 206 may notify the occupant that the start command has been accepted, by causing the LCD to display that the start command has been accepted.

In this case, meter control unit 206 may generate control signal S4 based on the result of determination by start necessity determination unit 204, and transmit control signal S4 to notification device 320. Alternatively, meter control unit 206 may notify the occupant that the start command for the system of vehicle 1 has been accepted during traveling, by using each of meter 300 and notification device 320.

Furthermore, it has been described in the present embodiment that, when the start command for the system of vehicle 1 has been received during traveling and when start of engine 10 is necessary, the “READY” mark on first display unit 302 is in the flashing state until start of engine 10 is completed. The flashing speed may be changed in accordance with the start situation of the system, for example.

For example, a first flashing speed during a period from when it is determined that start of engine 10 is necessary to when it is determined that start of engine 10 is possible may be different from a second flashing speed during a period from when it is determined that start of engine 10 is possible to when start of engine 10 is completed. The occupant can recognize that the process for starting the system progresses, for example, by making the first flashing speed higher or lower than the second flashing speed.

In addition, it has been described that rotational speed determination unit 208 in FIG. 3 determines whether start of engine 10 is possible or not, based on whether or not engine rotational speed Ne is prescribed rotational speed Ne(0) or lower. Rotational speed determination unit 208 may, however, determine whether start of engine 10 is possible or not, based on whether or not a predicted value of electric power generated when engine 10 is started at the current vehicle speed is within a range of the charge power that can be received in battery 70, for example For example, when the predicted value of electric power generated when engine 10 is started at the current vehicle speed is within the range of the charge power that can be received in battery 70, rotational speed determination unit 208 determines that start of engine 10 is possible.

In addition, it has been described in the present embodiment that, when restart of the system of vehicle 1 is requested during traveling, ECU 200 brings the “READY” mark into the constantly lighting state or the flashing state based on whether start of engine 10 is necessary or not, without checking the system. However, the present invention is not particularly limited to such operation. For example, when restart of the system of vehicle 1 is requested during traveling, ECU 200 may bring the “READY” mark into the flashing state and check the system of vehicle 1, and thereafter, maintain the “READY” mark in the constantly lighting state or the flashing state based on whether start of engine 10 is necessary or not.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 vehicle; 10 engine; 11 engine rotational speed sensor, 12, 13 resolver; 14 wheel speed sensor; 16 drive shaft; 20, 30 MG; 40 power split device; 50 sun gear; 52 pinion gear; 54 carrier; 56 ring gear; 58 speed reducer; 60 PCU; 70 battery; 80 drive wheel; 102 cylinder; 104 fuel injection device; 106 ignition device, 150 start switch; 156 battery temperature sensor; 158 current sensor; 160 voltage sensor; 200 ECU; 202 request determination unit; 204 necessity determination unit; 206 meter control unit; 208 rotational speed determination unit; 210 start possibility determination unit; 212 start completion determination unit; 300 meter; 302, 304, 306, 308, 310 display unit; 320 notification device.

1. A vehicle comprising:
a notification unit for notifying an occupant of a start state of a system of a vehicle;
an input unit for receiving a stop command and a start command for said system of said vehicle from said occupant; and
a control unit for notifying said occupant in a first manner, using said notification unit, that said start command has been accepted, when said stop command has been received at said input unit while said vehicle is traveling, and thereafter said start command has been received at said input unit during said traveling,
said first manner is a manner for notifying said occupant that said vehicle is in a traveling preparation state while said vehicle is in a stop state.

2. The vehicle according to claim 1, further comprising:
an internal combustion engine, wherein
said first manner is a manner for notifying said occupant that equipment necessary to start said internal combustion engine is in an operable state.

3. The vehicle according to claim 2, wherein
said first manner is a manner for notifying said occupant that said vehicle is in a traveling preparation state, and
when said stop command has been received at said input unit and thereafter said start command has been received at said input unit during said traveling, and when start of said internal combustion engine is requested, said control unit notifies said occupant in said first manner, using said notification unit, that said start command has been accepted, until said internal combustion engine starts.

4. The vehicle according to claim 1, further comprising:
a rotating electric machine for driving; and
an internal combustion engine, wherein
when said stop command has been received at said input unit and thereafter said start command has been received at said input unit during said traveling, and when said rotating electric machine for driving causes said vehicle to travel with said internal combustion engine stopped, said control unit notifies said occupant in a second manner different from said first manner, using said notification unit.

5. The vehicle according to claim 4, wherein
said first manner is a manner in which a mark having a predetermined shape flashes, and
said second manner is a manner in which said mark constantly lights up.

6. The vehicle according to claim 4, wherein
said first manner is a manner that allows said occupant to recognize by sound that said start command has been accepted, and
said second manner is a manner that allows said occupant to recognize by sound that said vehicle is in a traveling permitted state.

7. The vehicle according to claim 4, wherein
said notification unit includes:
a first display unit for displaying to said occupant in said first manner that said start command has been accepted, in response to reception of said start command at said input unit from said occupant; and
a second display unit provided at a position different from that of said first display unit, for displaying to said occupant in said second manner that said vehicle is in a traveling permitted state.

8. The vehicle according to claim 1, further comprising:
a drive shaft for causing a drive wheel to rotate;
an internal combustion engine;
a first rotating electric machine; and
a power transmission device mechanically coupling three elements, which are said drive shaft, an output shaft of said internal combustion engine, and a rotation shaft of said first rotating electric machine, said power transmission device utilizing any one of said three elements as a reaction force element, thereby allowing for transmission of motive power between the other two elements.

9. A control method for a vehicle used in a vehicle having a notification unit for notifying an occupant of a start state of a system of said vehicle, the control method comprising the steps of:
determining whether either one of a stop command and a start command for said system of said vehicle has been received from said occupant or not; and
notifying said occupant in a first manner, using said notification unit, that said start command has been accepted, when said stop command has been received while said vehicle is traveling, and thereafter said start command has been received during said traveling,
said first manner is a manner for notifying said occupant that said vehicle is in a traveling preparation state while said vehicle is in a stop state.
